(19) United States
(12) Patent Application Publication
(10) Pub. No.: US 2010/0139147 A1
(43) Pub. Date: Jun. 10, 2010

(54) FLOATING TRAWL METHODS AND ARRANGEMENTS

(75) Inventors: Kjell Inge Rokke, Oslo (NO); Hans Jahn Leithe, Valderoya (NO); Robert Ernsten, Colfito (CR)

Correspondence Address: VOLPE AND KOENIG, P.C., UNITED PLAZA, SUITE 1600, 30 SOUTH 17TH STREET, PHILADELPHIA, PA, 19103, US

(73) Assignee: AKER BIOMARINE ASA, Oslo (NO)

(21) Appl. No.: 12/445,095

(22) PCT Filed: Oct. 17, 2007
(86) PCT No.: PCT/NO07/00362

§ 371 Date: Feb. 16, 2010

(30) Foreign Application Priority Data
Oct. 18, 2006 (NO) 20064727
Mar. 22, 2007 (NO) 20071503

(51) Int. Cl. A01K 73/04; A01K 74/00; A01K 75/00

(52) U.S. Cl. 43/4.5; 43/9.7; 43/6.5; 43/9.8

(57) ABSTRACT

A method and an arrangement for trawling wherein trawl are bags positioned one above the other and towed by a single trawl vessel is disclosed. The bag(s) are continuously emptied of caught seafood/biomass via an injector assisted suction hose connected to a bottom end of the bag(s), and leading to the trawler vessel. In the case of two trawl bags, one above the other, the uppermost trawl bag is along the upper trawl opening portion equipped with a plurality of buoyancy bodies, and the lower trawl bag's lower trawl opening portion, at the outer ends, is equipped with weights or sinkers. Spreading of trawl opening(s) is effected either by otter boards, or a spreading member linked to the trawl opening portions. Tension lines pass from the outer ends of the upper trawl opening portion to the outermost positioned joining points for the trawl bags, and to the weights or sinkers.

### FIELD OF INVENTION

The present invention relates to methods and arrangements for trawling by means of a single trawler.

### BACKGROUND

A conventional way of properly spreading the opening of a trawl bag is by using otter-board or so-called “trawl doors” and/or by using so-called steering weights. However, steering weights are merely useful for bottom trawling, not for so-called pelagic trawling where the trawl bag is closer to the sea surface than to the sea bottom. This is in particular the case when catching biomass/seafood such as krill.

An alternative solution to using otter boards or trawl doors as mentioned above involving the towing of, for example, one or two trawl bags is known, inter alia, from Norwegian Patent Application No. 2006 1315, where spreading of the trawl bag or bags is made by use of hydrofoil, and where an injector assigned to a suction line is located below the surface of the water in an upper, upward-positioned portion of the suction line at a position between the trawl bag mouth and the trawler vessel. Using a hydrofoil requires, however, sufficient heavy duty handling equipment on-board the trawler vessel in view of the trawl conventionally having an opening width of 18-20 meters and the rigid hydrofoil requiring a corresponding length for proper spreading purposes, thereby also a corresponding place for storage on-board. Further, not only the length, but also the weight of the hydrofoil is a consideration as regards said handling equipment.

When catching, inter alia, biomass/seafood such as krill, it is important that the krill is taken from the trawl bag up to the trawler vessel functioning as a production vessel as quickly as possible and as undamaged as possible, as the krill are easily spoiled and their quality diminished if they are not processed as quickly as possible after being caught in the trawl.

Trawling for krill requires trawl bags with a small mesh size and it is therefore of detriment to the catch if the trawl bag is too large, as it will then take a relatively long time for the caught krill to be pumped out of the trawl bag.

Furthermore, during continuous trawling with only one trawler vessel, it may be difficult for reasons of stability and equipment availability to have a plurality of trawl bags in the transverse direction, especially more than two, and there will be a need for swing-out cranes on board the trawler vessel.

An obvious idea would then be to use one large trawl bag instead of two or more smaller ones.

However, as mentioned, this is not practical or prudent when catching krill, blue whiting and the like because the catch must be as alive as possible when it is pumped on board the production ship, as the quality of the catch will otherwise rapidly become significantly diminished because the catch remains too long and in too large a quantity in the trawl bag before being pumped on board the trawler vessel. In reality, this means that some of the catch dies before it is brought on board. This is critical, especially for krill, as it degrades very quickly in such a situation, so that the further processed product is of a significantly diminished quality/nutritional value, which is highly undesirable. It is therefore an object of the present invention to also solve this problem.

### SUMMARY

The present invention is therefore concerned with finding ways and means for efficient, yet safe and reliable trawling methods and arrangements, in particular for use with pelagic trawling for catching krill, blue whiting or the like. However, the invention is not to be construed as to be limited to catching of such species, and through minor modifications of the concepts as herein disclosed, the invention can be applied to the catching of other species.

Furthermore, it is an object of the invention to also provide for an efficient spreading of a single trawl bag without the use of conventional otter board/trawl doors.

Also the invention has as an object to provide for convenient towing of the trawl bag arrangements, irrespective of whether the there is provided for a single trawl bag or an arrangement of a plurality of trawl bags.

Non-limiting exemplary embodiments of the invention will now be described in more detail with reference to the attached drawings.

### BRIEF DESCRIPTION OF THE DRAWINGS

FIG. 1 is a schematic illustration of a first embodiment of the invention.

FIG. 2 is a schematic illustration of a variant of the exemplary embodiment according to FIG. 1.

FIG. 3 is a schematic illustration of the embodiments according to FIGS. 1 and 2, seen from the side.

FIG. 4 is a schematic illustration of a second exemplary embodiment according to the invention.

FIG. 5 is a schematic illustration of a variant of the exemplary embodiment according to FIG. 4.

FIG. 6 is a schematic illustration of a further modification of the embodiment shown in FIGS. 4 and 5.

FIG. 7 is a schematic illustration of a further modification of the embodiments shown in FIGS. 4-6.

FIG. 8 is a schematic illustration showing more details of the embodiment illustrated in FIG. 7, seen from above.

FIG. 9 shows the embodiments illustrated in FIGS. 6-8, seen from the side.

FIG. 10 is a schematic illustration of the embodiment shown in FIGS. 6 and 7.

FIG. 11 shows the embodiment illustrated in FIGS. 4 and 10, seen from the side.

FIG. 12 shows a modification of the arrangement as illustrated in FIGS. 8 and 9.

FIG. 13 shows the solution in FIG. 12 together with a trawler vessel.

FIG. 14 shows a further modification of the arrangement illustrated in FIGS. 8 and 9.

FIG. 15 shows the solution according to FIG. 14 together with a trawler vessel.

FIG. 16 shows a single trawl embodiment.

FIG. 17. shows the single trawl embodiment together with a trawler vessel.

FIG. 18 shows an alternative single trawl embodiment.

FIGS. 19, 20 and 21 show embodiments for deploying trawls or sets of trawls from outriggers on a trawler vessel.

FIGS. 22a-22g show exemplifying cross-sections of a rigid, elongate trawl opening spreading member.

### DETAILED DESCRIPTION OF THE PREFERRED EMBODIMENTS

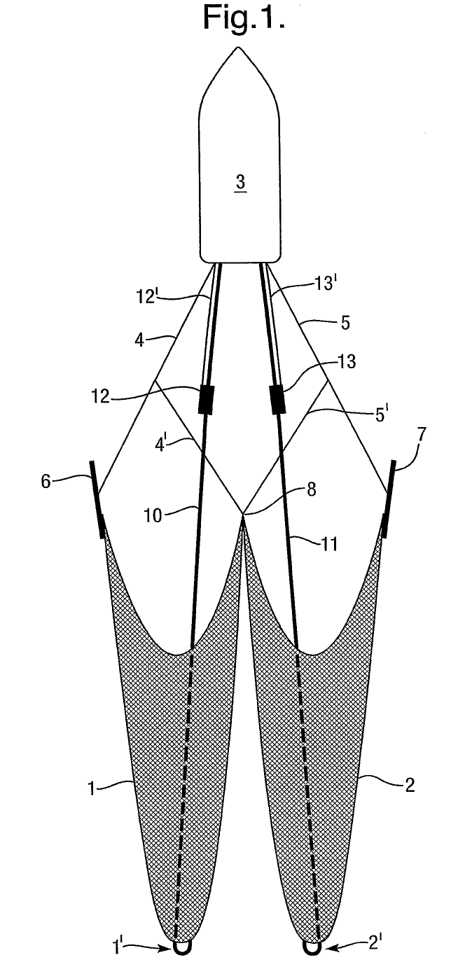

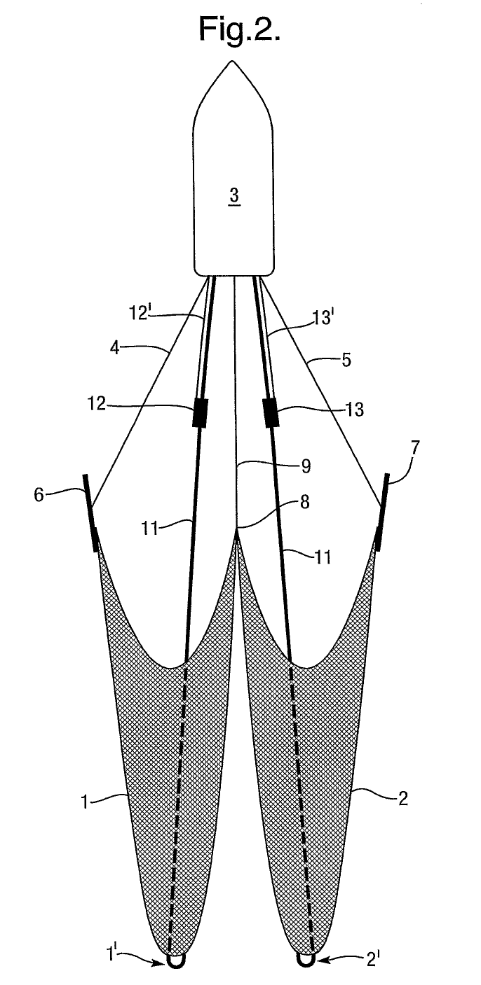

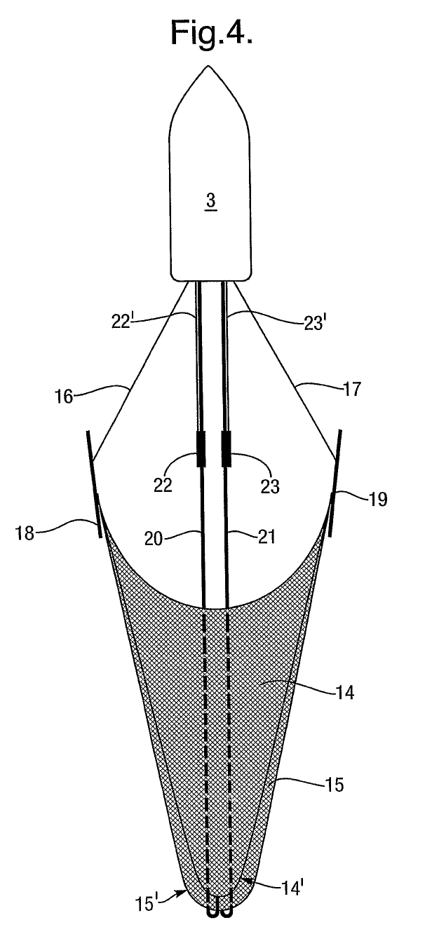

FIGS. 1 and 2 show, as a non-limiting example, two trawl bags 1; 2 that are towed by one trawl vessel 3. According to FIG. 1, traditional tow lines 4, 5 running to otter boards or so-called trawl doors 6, 7 are used, and with a crow's foot solution 4′, 5′ for connection to a connection point 8 for the trawl bags 1, 2, whilst FIG. 4 shows the tow lines 4, 5 running from the vessel 3 to the otter boards 6, 7, and an additional tow line 9 running to said connection point 8. The trawl bags here will be joined or connected together at the point 8.

A suction hose 10, 11 which passes through a respective injector 12, 13 is connected to the bottom end 1′, 2′ of each trawl bag 1, 2. The injectors 12, 13 are supplied with air via air supply lines 12′, 13′.

FIG. 4 shows two joined trawl bags 14, 15 that are positioned one above the other and that are towed by the trawler vessel 3 with the aid of tow lines 16, 17 and with the use of otter boards 18, 19. The lower opening portion of the upper trawl bag 14 is advantageously fastened to or forms a connection with the upper opening portion of the lower trawl bag 15 at two or more suitable points.

During trawling, the trawl bags 14, 15 are continuously emptied of caught seafood/biomass via a suction hose 20, 21 connected at a bottom end 14′, 15′ of the respective trawl bag, and said seafood/biomass is passed via the respective suction hose 20, 21 and associated injector 22, 23 to the trawler vessel 3. The injectors 22, 23 are supplied with air from the vessel via supply hoses 22′, 23′.

In a practical embodiment of the invention, the trawler vessel 3 is a production vessel.

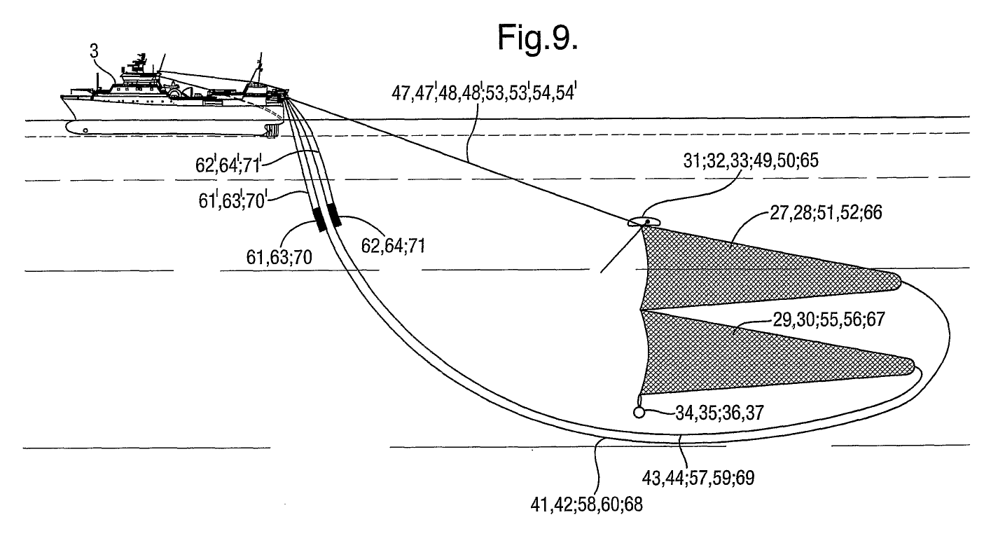

When the trawl bags are thus positioned one above the other, a solution allowing the injector 22; 23 to be located in an area between the forward portion of the respective trawl bag and the trawler vessel could be appropriate, and the suction hoses may advantageously be passed beneath the lowest of the trawl bags, as can be seen from FIG. 9.

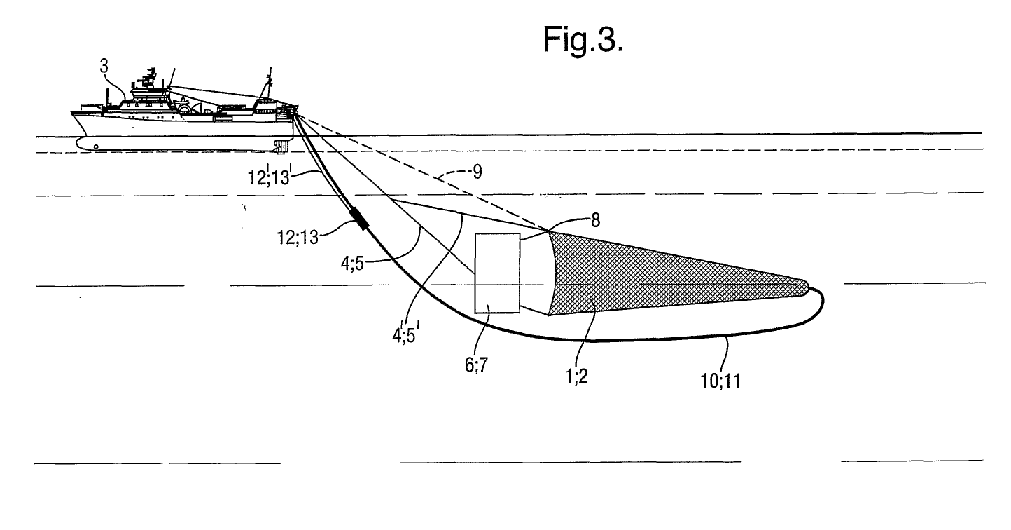

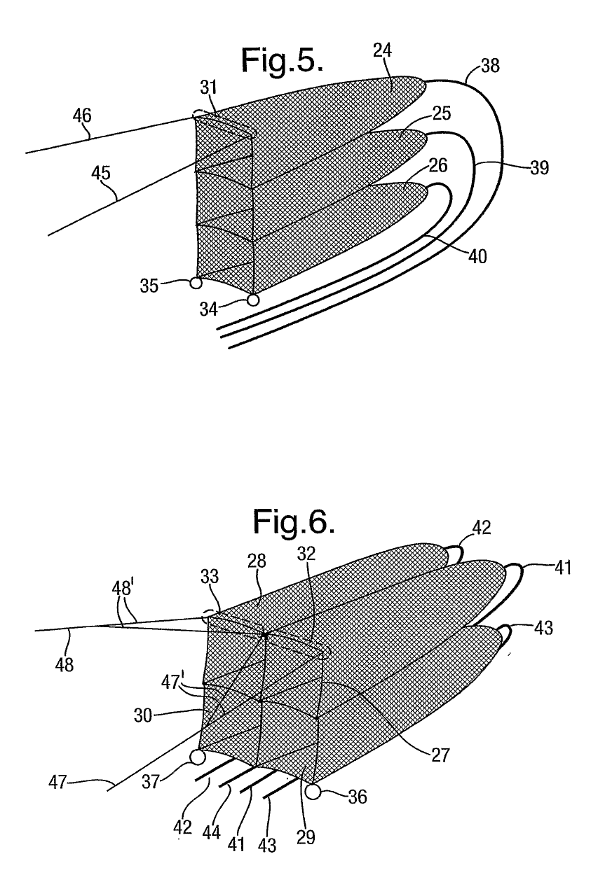

Although in the preceding examples according to FIGS. 1, 2, 3 and 4, the towing of two trawl bags is shown, it is conceived that it is possible to tow, for example, three joined or cooperating trawl bags 24-26, one above the other in the vertical direction, or optionally four joined trawl bags 27-30, with two in the transverse direction and two in the vertical direction, as illustrated in FIGS. 5 and 6, respectively. In this solution, the use rigid, elongate spreading member or members 31 (FIG. 5); 32, 33 (FIG. 6) with associated sinkers 34, 35; 36, 37 is also conceivable, and such member(s) would suitably be formed as e.g. a rigid tube, pipe, rigid rod or a tubular member having internal stiffening members or stays. The profile of such member(s) could be circular, oval, polygonal, water drop shaped, conic section shaped, hydrofoil or aerofoil shaped, or with any suitable shape that is hydro-dynamical, as e.g. shown on FIGS. 22a-22g. The trawl bags can be continuously emptied through respective suction hoses 38-40; 41-44, injectors (not shown) and then on board at least one of the trawler vessels. Although three joined trawl bags lying one above the other are shown in FIG. 5, in practical application it is conceivable, as an alternative, to have, for example, four trawl bags, but the embodiment preferred at present advantageously utilises two trawl bags, as described in several of the exemplary embodiments. Although FIG. 6 shows four trawl bags, with two at each level, it may of course also be conceivable to have six trawl bags, for example, with three trawl bags at each of two levels, or two trawl bags at each of three levels.

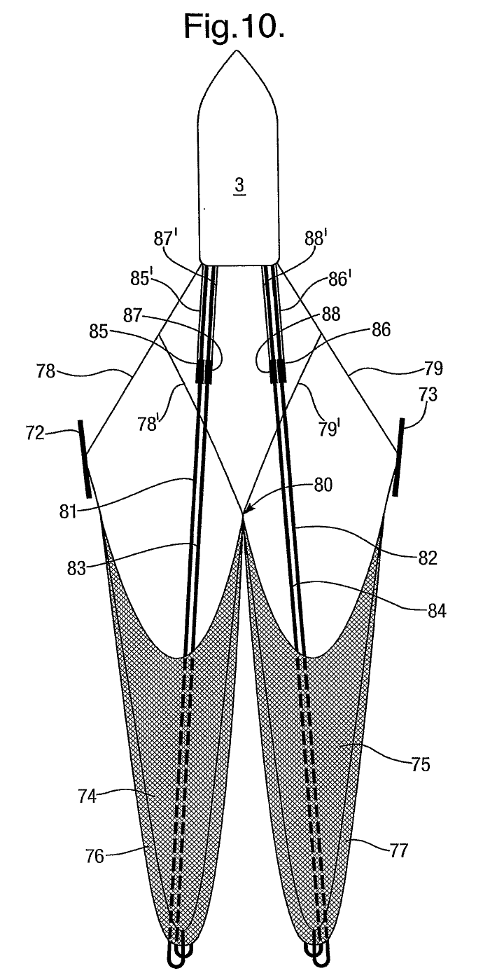

In the solution shown in FIG. 5, but especially the solution in FIG. 6, it is also conceivable to use otter boards instead of said rigid, elongate spreading member(s) to spread the trawl bags. This has a practical aspect, especially if the trawls are large and have a large mesh size to better catch larger seafood than krill and blue whiting. In such cases, the trawl bags can be so wide at the mouth that the rigid, elongate member(s) will simply be too long, too heavy and too unwieldy, in particular under rough weather conditions at sea. When using otter boards, the use of sinkers will not always be necessary. A more detailed explanation of this aspect of the invention is given in connection with FIGS. 10 and 11.

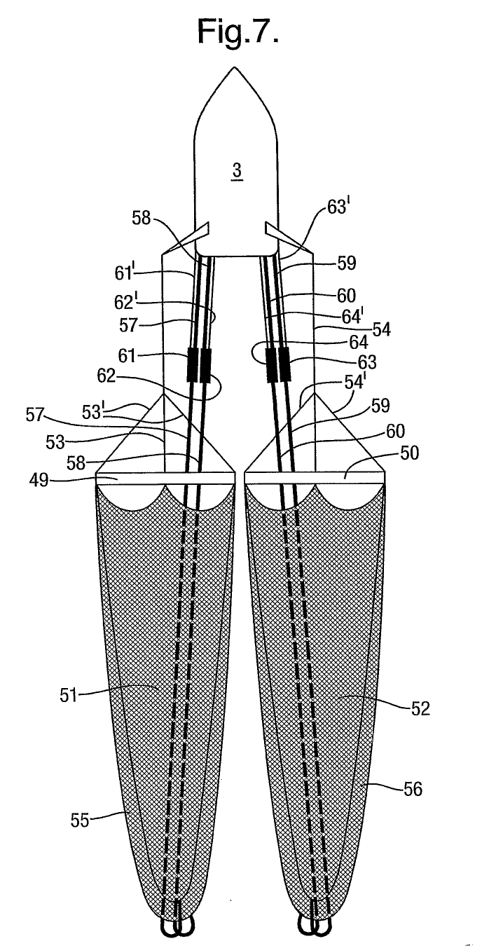

The solution shown in FIG. 7 is in reality a variant of the solution that can be seen purely schematically from FIG. 5 and from FIG. 6. In this example, to avoid the use of otter boards, a solution is shown with two rigid, elongate spreading members 49, 50 that secure and spread the upper mouth portion of the respective upper trawl bag 51, 52, and where tow lines 53, 53′, 54, 54′ from the trawler vessel 3 booms 3′, 3″ are fastened to the rigid, elongate spreading members 49, 50. The rigid, elongate spreading members 49, 50 are advantageously not connected to each other. Below each trawl bag 51, 52 there is at least one additional trawl bag 55, 56. As shown and described in connection with FIG. 5, the trawl bags that lie one above the other are joined along adjacent mouth portions at least two points, preferably at the outer points. To the bottom end of each trawl bag there is attached a suction hose 57-60 that passes through a respective injector 61-64, each injector being supplied with air from the trawler vessel 3 via air hose 61′-64′.

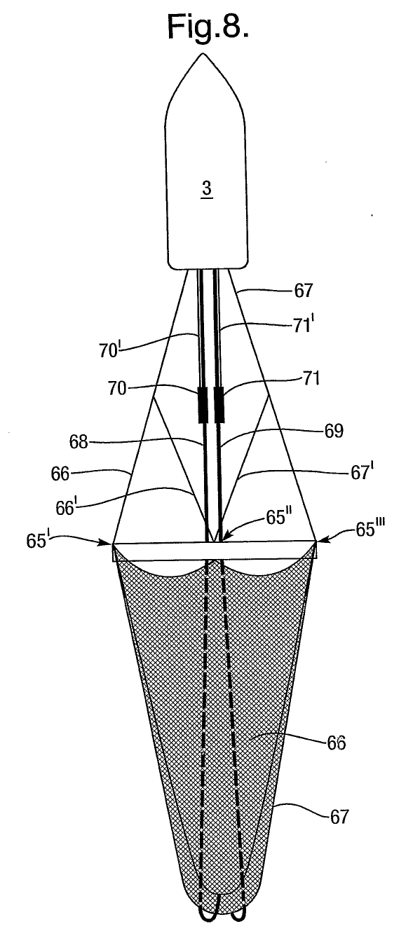

As an alternative to using otter boards 18, 19 as shown in FIG. 4, the embodiment in FIG. 8 instead uses a rigid, elongate spreading member 65 for spreading the uppermost trawl bag 66 and thus also the lowermost trawl bag 67. In reality, FIG. 8 shows half of the equipment shown in FIG. 7, but with this solution, outriggers on the trawler vessel 3 may, if desired, be avoided. The trawl bag 30 is fastened to the rigid, elongate spreading member 65 at least two, but preferably at least three points 65′, 65″, 65′″. The rigid, elongate spreading member can be towed by two tow lines 66, 67, with branches 66′, 67′ in a crow's foot solution, or optionally by three tow lines, where the middle line (not shown) runs to the midpoint 65″ of the rigid, elongate spreading member. In other respects, that shown in FIGS. 10 and 11 is the same as that shown and explained in connection with FIGS. 8 and 9. A suction hose 68, 69 is passed from the bottom end of each trawl bag 66, 67 to the trawler vessel 3 via a respective injector 70, 71, the injector 70, 71 being supplied with air from the trawler vessel via an air hose 70′, 71′.

The solution shown in FIG. 10 is a variant of the solution shown in FIG. 7, and in reality a practical embodiment of the solution shown in FIG. 6, i.e., with at least two juxtaposed trawl bags at least two levels, and where the trawl bags are advantageously connected together.

It is recognised that when using very large trawl bags, i.e., not typical for catches of krill, but more for medium-sized fish, rigid, elongate spreading members may be too unwieldy because of their length and thus substantial weight, especially when using only one trawler vessel 3. Because such rigid, elongate spreading members must have good rigidity and at the same time be solid enough to be able to resist impacts and loads, especially when hoisted on board and deployed, their weight may be substantial, in some cases 250-1000 kg/meter. In this alternative example, otter boards 72, 73 are used to secure and spread the mouth portion of respective trawl bag 74, 75, 76, 77, and tow lines 78, 78′, 79, 79′ from the trawler vessel 3 are fastened respectively to the otter boards 72, 73 and to a connection point 80 at the upper mouth portion of the trawl bags 74, 75.

As shown and described in connection with FIG. 6, the trawl bags that lie above one another are advantageously joined along horizontally adjacent mouth portions at least two points, preferably at the outer points, and similarly, vertically adjacent mouth portions are advantageously joined at least two points. Appropriate joining points may advantageously be at the corners of the trawl bag mouth. To the bottom end of each trawl bag 74-77 there is attached a suction hose 81-84 which passes through a respective injector 85-88, each injector being supplied with air from the trawler vessel 3 via air supply hose 85′-88′. If there is a need, sinkers 89, 90, like the sinkers 36, 37 shown in FIG. 6, may optionally be positioned at the lower mouth area of the trawl bags.

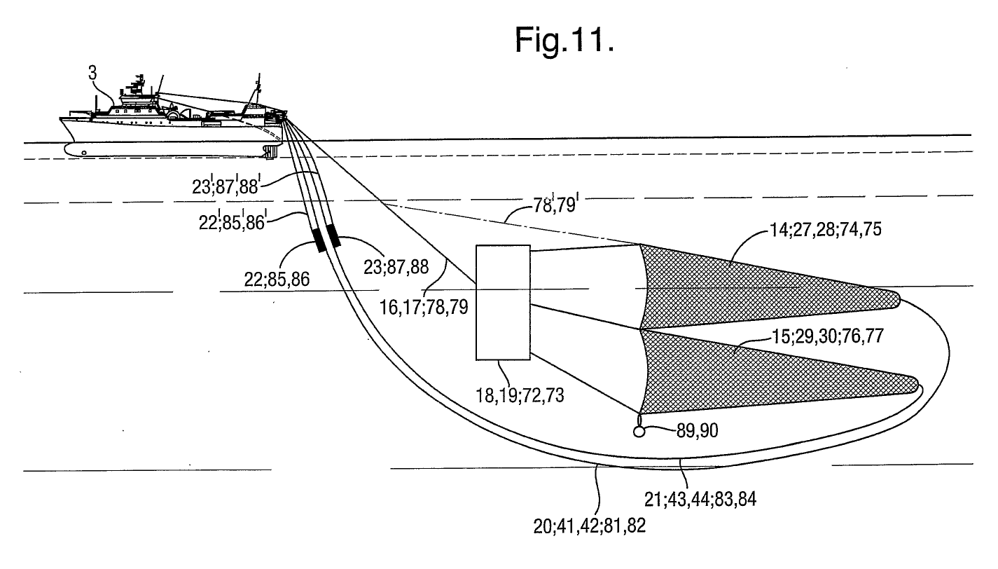

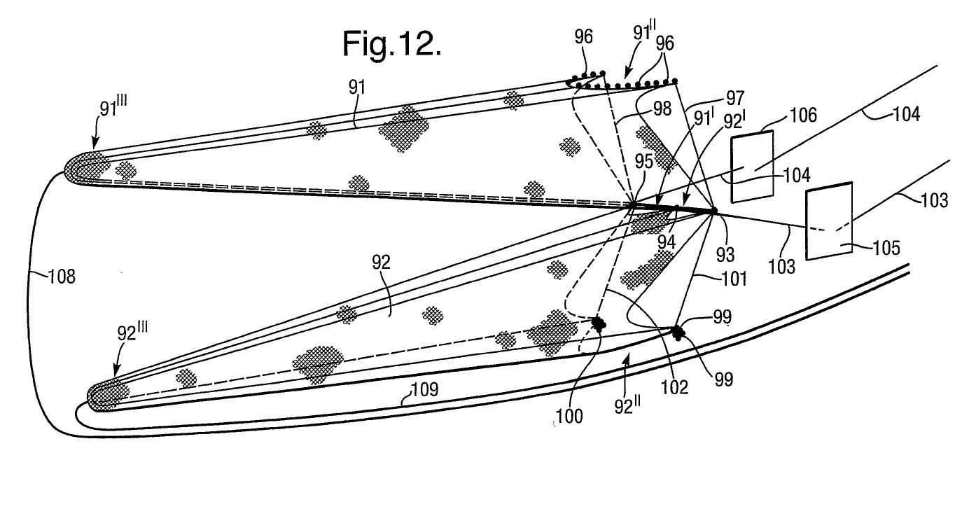

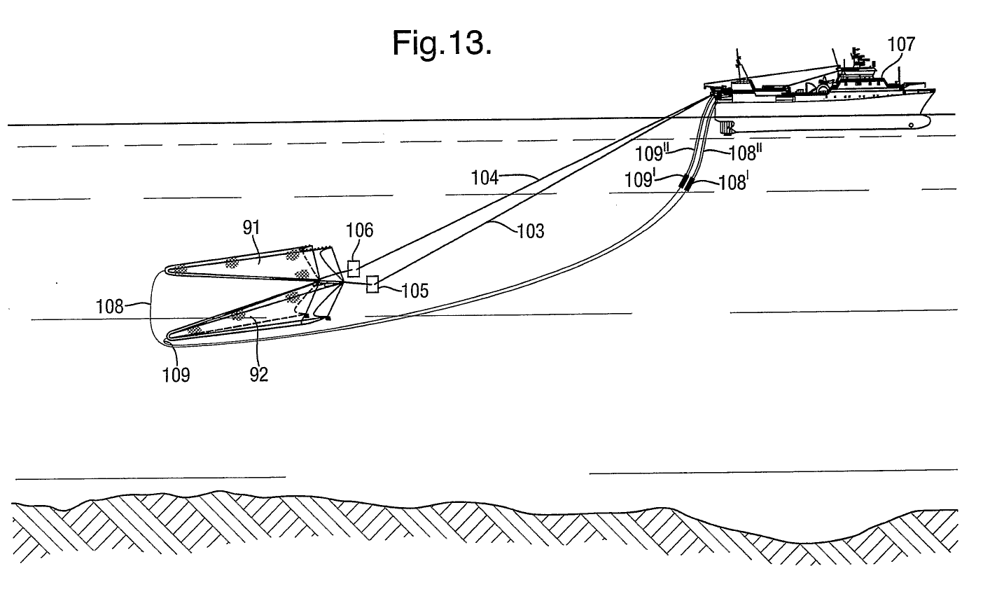

FIGS. 12 and 13 show a solution in which two trawl bags 91, 92 are positioned one above the other and connected at two or preferably at least three points. The uppermost 91 of the trawl bags is fastened at a lower portion 91′ of the trawl opening at, for example, three points 93-95 to the upper portion 92′ of the trawl opening of the lower trawl bag 92. The upper portion 91″ of the trawl opening of the trawl bag 91 is equipped with a plurality of floats 96, and it will be expedient to have present tension lines 97, 98 connecting respective outer ends of the upper portion 91″ to respective connection points 93 and 95. The lower portion 92″ of the trawl opening of the trawl bag 92 is equipped at its outer ends with a respective sinker or respective weight 99, 100, and it will be expedient to have present tension lines 101, 102 connecting respective outer ends of the lower portion 92″ to respective connection points 93, 95. The trawl bags 91, 92 are towed by means of tow lines 103, 103′ and 104, 104′ via respective otter boards 105, 106 from a trawler vessel 107, where the tow lines 103′, 104′ which run from the respective otter board 105, 106 towards the trawl bag array are expediently secured at the outer joining points 93, 95.

Suction hoses or conveying hoses 108, 109 are run, preferably together, from the trawler vessel 107 down beneath the lowest 92 of the trawl bags, and the hose 108 is connected to the downstream end 91′″ of the upper trawl bag 91 whilst the hose 109 is connected to the downstream end 92′″ of the lower trawl bag 92.

Injectors 110, 111 are connected in an upwardly rising portion of the hoses 108, 109 to effect pumping of the catch on board the trawler vessel 107.

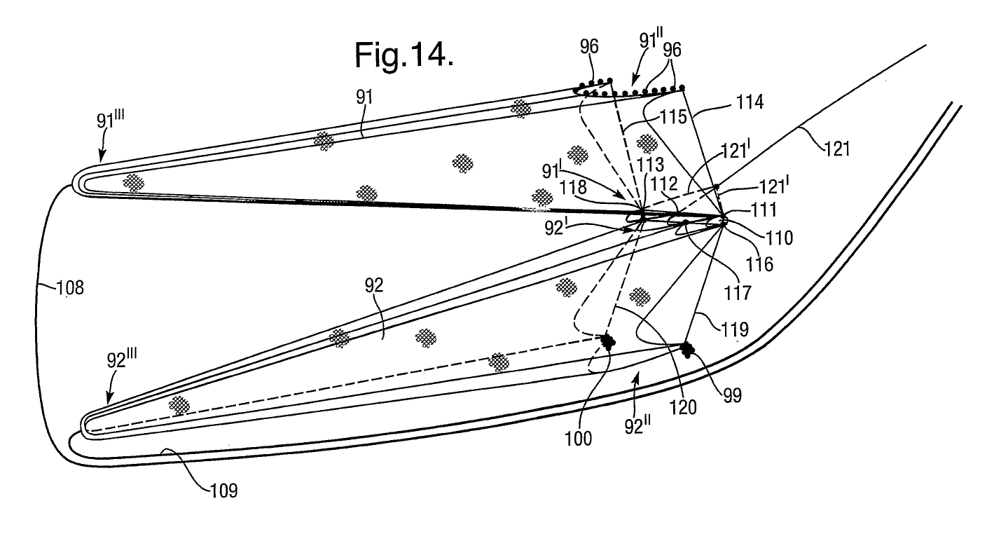

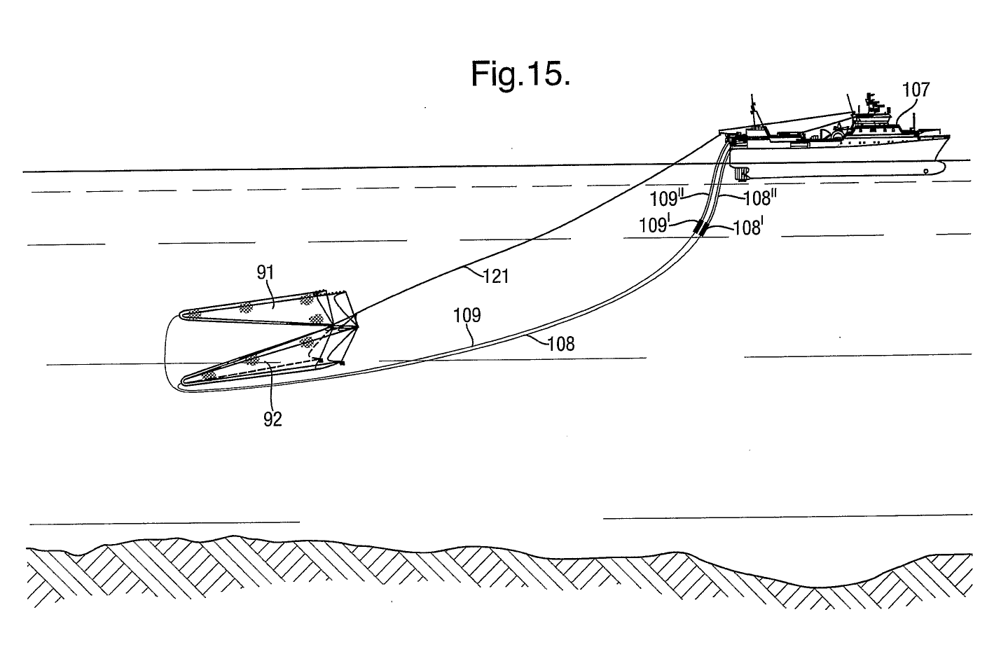

FIGS. 14 and 15 show a solution in which the two trawl bags 91, 92 are positioned one above the other and connected via a rigid, elongate spreading member 110, e.g. a hydrofoil or a tubular member, suitably of hydro-dynamically suitable cross-section. The uppermost 91 of the trawl bags is fastened at the lower portion 91′ of the trawl opening at least three points 111-113 to the rigid, elongate spreading member 110. The upper portion 91″ of the trawl opening of the trawl bag 91 is, as mentioned, equipped with a plurality of floats 96, and it will be expedient to have present tension lines 114, 115 (corresponding to the tension lines 97, 98 in FIG. 12) connecting respective outer ends of the upper portion 91″ to respective outer portions of the rigid, elongate spreading member 110. The lowermost 92 of the trawl bags is fastened at the upper portion 92′ of the trawl opening at least three points 116-118 to the rigid, elongate spreading member 110. The lower portion 92″ of the trawl opening of the trawl bag 92 is, as shown in FIG. 12, equipped at its outer ends with a respective sinker or respective weight 99, 100, and it will be expedient to have present tension lines 119, 120 (corresponding to the tension lines 101, 102 in FIG. 12) connecting respective outer ends of the lower portion 92″ to respective outer portions of the rigid, elongate spreading member 110. The rigid, elongate spreading member 110 with the trawl bags 91, 92 attached thereto is towed by means of one tow line 121 from the trawler vessel 107, the tow line 121 being run down to the centre of the rigid, elongate spreading member 110 and having branches 121′, 121″ to the outer ends of the rigid, elongate spreading member 110. It is of course also possible to envisage the use of two tow lines on the rigid, elongate spreading member, for example, fastened at or at a distance from a respective end thereof.

In a similar way as explained with respect to FIG. 12, the suction hoses or conveying hoses 108, 109 are run, preferably together, from the trawler vessel 107 down beneath the lowest 92 of the trawl bags, and the hose 108 is connected to the downstream end 91′ of the uppermost trawl bag 91 whilst the hose 109 is connected to the downstream end 92′ of the lower trawl bag 92.

Injectors 108′, 109′ are connected in the upwardly rising portion of the hoses 108, 109 to effect pumping of the catch on board the vessel 107. The injectors 108′, 109′ are supplied with air from the vessel 107 via air supply hoses 108″, 109″, as indicated in a purely schematic manner.

One advantage of the solution shown in FIGS. 12-15 is that a change of trawling direction can be made somewhat faster than with two juxtaposed trawl bags. Furthermore, the solution involving the use of conventional otter boards, as shown in FIGS. 12 and 13, will be advantageous if the use of a rigid, elongate spreading member is impractical due to, for example, a lack of storage space on board the vessel, and in the solution shown in FIGS. 14 and 15, there is a need for only one common rigid, elongate spreading member, which for reasons of possible limited storage space on board the trawler vessel 107 may be advantageous and at the same time one rigid, elongate spreading member would be easy to handle.

The location of the fastening points 111-113 and 116-118 on the rigid, elongate spreading member for the trawl bags 91 and 92, respectively, may be instrumental in how the rigid, elongate spreading member will move in the sea when towed, i.e., has a tendency to move upwards, endeavours to remain at one level or seeks to move downwards. The cross-sectional shape of the rigid, elongate spreading member will thus be of importance as to how it will generally behave when towed by the trawler vessel, i.e. due to its inherent hydro-dynamical properties.

Furthermore, the fastening points on the rigid, elongate spreading member for the tow lines 121-121″ could have an impact on the behaviour of the rigid, elongate spreading member, in particular if is shaped like a typical hydrofoil, as regards its movement tendencies.

It is of course also conceivable that the fastening point 111 corresponds to point 116, that point 112 corresponds to point 117, and point 113 corresponds to point 118, so that there are common fastening points for both the trawls on the rigid, elongate spreading member.

For further or alternatively controlling the rigid, elongate spreading member, e.g. when shaped as a hydrofoil, it can, for example, be equipped with at least one upright wing which serves as a rudder for lateral steering and lateral stabilisation of the hydrofoil. It is also possible to allow such hydrofoil shaped member to be equipped with adjustable flaps that are upwardly tiltable to adjust the hydrofoil's lifting power in water during towing of the hydrofoil and the trawl bags, as is also described in said Norwegian Patent Application 20061315.

When using the otter boards 105, 106 or just the one rigid, elongate spreading member 110, it is thus possible to spread the trawl openings of the two trawl bags simultaneously, the weights 99, 100 causing the lower transverse length of the opening of the lower trawl bag 92 to be kept at roughly the correct size, and, similarly, the floats 96 and the tension lines 97, 98; 114, 115 causing the upper transverse length of the opening of the upper trawl bag 91 to be kept at roughly the correct and desired size.

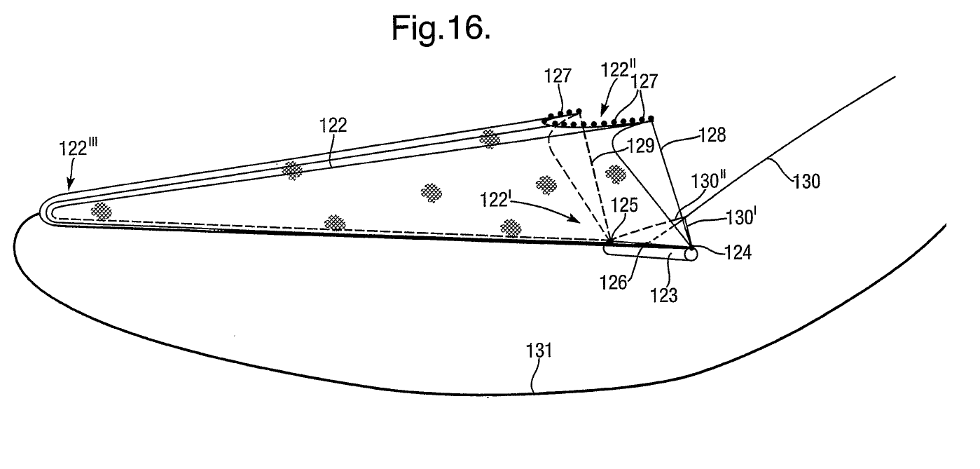

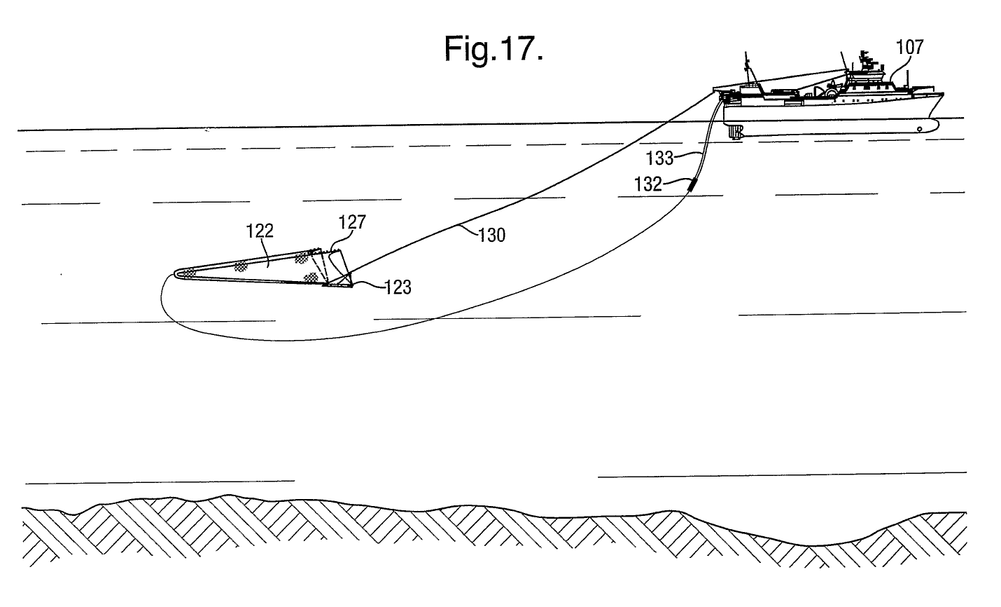

FIGS. 16 and 17 show a solution in which a trawl bag 122 is connected to rigid, elongate spreading member 123, e.g. a hydrofoil or a tubular member, suitably of hydro-dynamically suitable cross-section or of a cross-section as disclosed earlier in the disclosure. The trawl bag 122 is fastened at the lower portion 122″ of the trawl opening at least three points 124, 125, 126 to the rigid, elongate spreading member 123. The upper portion 122″ of the trawl opening of the trawl bag 122 is equipped with a plurality of floats 127, and it will be expedient to have present tension lines 128, 129 connecting respective outer ends of the upper portion 122″ to respective outer portions of the rigid, elongate spreading member 123. The rigid, elongate spreading member 123 with the trawl bag 122 attached thereto is towed by means of one tow line 130 from the trawler vessel 107, the tow line 130 being run down to the centre of the rigid, elongate spreading member 123 and having branches 130′, 130″ to the outer ends of the rigid, elongate spreading member 123. It is of course also possible to envisage the use of two tow lines on the rigid, elongate spreading member, for example, fastened at or at a distance from a respective end thereof.

A suction hose 131 is provided, extending between the trawler vessel 107 and an end region 123′″ of the trawl bag 122. The operation of the suction hose is assisted by an air injector 132 receiving air supply from the trawler vessel via an air supply hose 133.

Furthermore, the fastening points on the rigid, elongate spreading member for the tow lines could have an impact on the behaviour of the rigid, elongate spreading member, in particular if is shaped like a typical hydrofoil, as regards its movement tendencies.

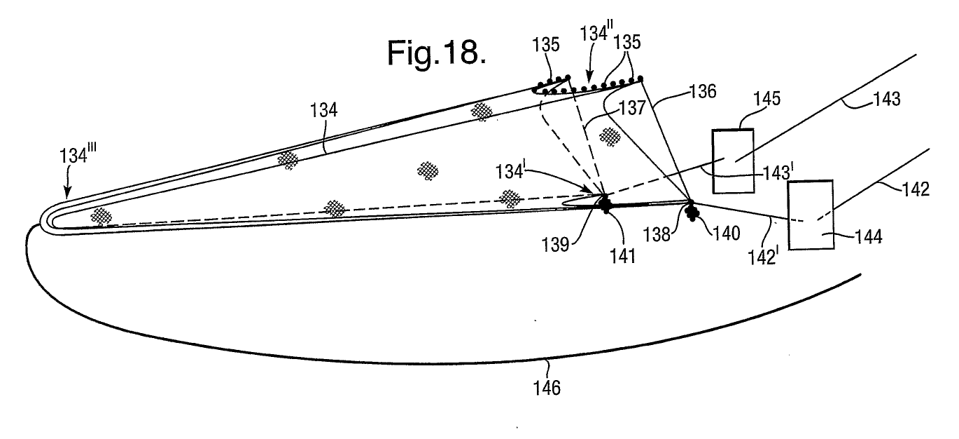

FIG. 18 show a solution in which a single trawl bag 134 at the upper portion 134″ of the trawl opening of the trawl bag 134 is equipped with a plurality of floats 135, and it will be expedient to have present tension lines 136, 137 connecting respective outer ends of the upper portion 134″ to respective connection points 138 and 139 of the lower portion of the trawl bag 134. The lower portion 134′ of the trawl opening of the trawl bag 134 may at its outer ends be provided with a respective sinker or respective weight 140, 141. The trawl bag 134 is towed by means of tow lines 142, 142′ and 143, 143′ via respective otter boards 144, 145 from a trawler vessel 107, where the tow lines 142′, 143′ which run from the respective otter board 144, 145 towards the trawl bag are expediently secured at the outer connection points 138, 139.

A suction hose 146 extends from the trawler vessel 107 down to a bottom region 134′″ of the trawl bag in order to on a continuous basis withdraw from the trawl bag 134 the seafood/biomass caught in the trawl bag. An injector, like injector 132 of FIG. 17 is supplied with air from the trawler vessel 107 via a supply hose, like hose 133.

Based on the location of the otter boards 144. 145, it will be appreciated that the sinkers or weights 140, 141 can suitably be dispensed with.

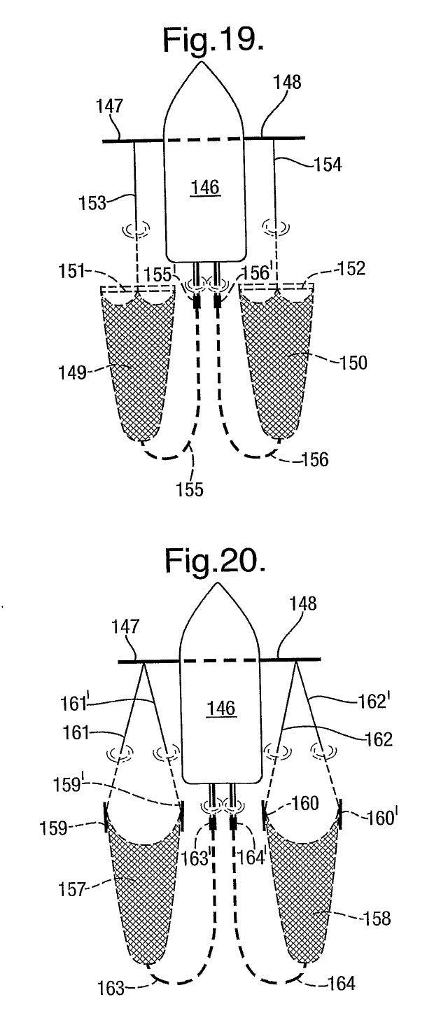

FIGS. 19-21 show illustrative examples as to how sets of trawl bags can be deployed in the sea from the trawler vessel 146. The trawler vessel is provided with a pair of outriggers or beams 147 and 148 on the port and starboard sides of the vessel. The outriggers could be placed anywhere between the bow and stern of the vessel, but suitably in a mid-ships region, as indicated. These outriggers may e.g. be of a type that can be tilted to an upright position or be turned to lie alongside the vessel when not in use, or they could be of a more permanent type, e.g. forming a unitary single beam, as indicated by the dotted line.

As shown on FIG. 19 the trawl bags 149, 150 could be of a type having their opening spread by means of a rigid, elongate spreading member 151, 152 with sinkers or weight (not shown) at the lower portion of the trawl bag opening. A single tow line 153, 154 for the respective bag 149, 150 will be required and suction hoses 155, 156, assisted by injectors 155′ and 156′ are at one end connected to the vessel 146 and at the other end connected to a bottom end of the respective trawl bag 149, 150, as shown. Although shown on FIG. 19 with just two trawl bags, i.e. one towed from either side of the trawler vessel 146, the configuration with two trawl bags towed from either side of the vessel, as indicated on FIG. 7, could be envisaged.

As shown on FIG. 20 the trawl bags 157, 158 could be of a type having their opening spread by means of otter boards 159, 159′ and 160, 160′ with sinkers or weight (not shown) at the lower portion of the trawl bag opening, if appropriate. A pair of tow lines 161, 161′ and 162, 162′ for the respective bag 157, 158 and associated otterboards 159, 159′ and 160, 160′ will be required. Suction hoses 163, 164, assisted by injectors 163′ and 164′ are at one end connected to the vessel 146 and at the other end connected to a bottom end of the respective trawl bag 157, 158, as shown. Although shown on FIG. 20 with just two trawl bags, i.e. one towed from either side of the trawler vessel 146, a configuration with e.g. two trawl bags towed from either side, as indicated on FIG. 7, could be envisaged, thereby representing a modification of the embodiment on FIG. 19.

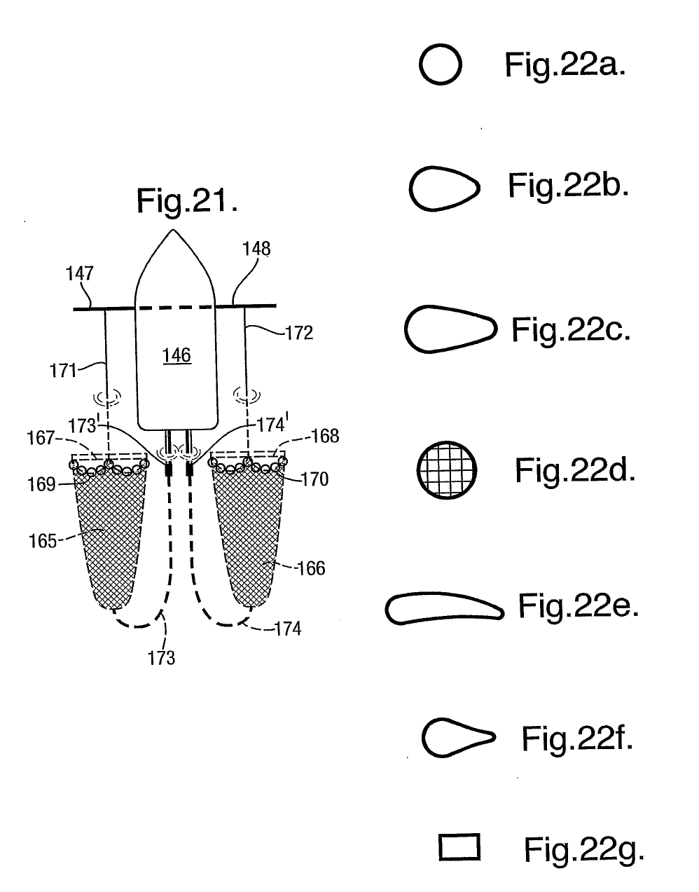

As shown on FIG. 21 the trawl bags 165, 166 could be of a type having their opening spread by means of a rigid, elongate spreading member 167, 168 at the lower portion of the trawl bag opening, and with floats 169, 170 at the upper portion of the trawl bag, i.e. a configuration as shown on FIGS. 16 and 17. A single tow line 171, 172 for the respective bag 165, 166 will be required. Suction hoses 173, 174, assisted by injectors 173′ and 174′ are at one end connected to the vessel 146 and at the other end connected to a bottom end of the respective trawl bag 165, 166, as shown. Although shown on FIG. 21 with just two trawl bags, i.e. one towed from either side of the trawler vessel 146, the configuration with two trawl bags towed from either side, as indicated on FIG. 7, could be envisaged. Thus a trawl bag configuration as shown on FIGS. 14 and 15 towed from either side of the vessel is envisaged.

The present invention will be especially advantageous for pelagic fishing, i.e., for use with floating trawls, and especially for catching, for example, krill and blue whiting, although also the catching of other seafood or biomass is conceivable. Although it is shown that the suction hoses are passed under the trawl bags or the trawl bag array, it will be understood that it will also be possible, from the bottom end of the trawl bags to run the injector-equipped suction hoses upwards and at a distance above the top level of the trawl bags and then to the trawler vessel. This may be advantageous when catching other biomass/seafood than, for example, krill and blue whiting, such as fish of small or intermediate size, as such fish will be more easily distracted or frightened by hoses that extend upwards in the inflow area in front of the trawl bag mouth, as well as turbulence caused by such located hoses.

1. A method for trawling by means of a single trawler vessel, comprising
towing a plurality of trawl bags by means of said single trawler vessel,
wherein such plurality of trawl bags are deployed by selection from one of the group of:
a) at least two trawl bags positioned one above the other, and
b) at least two juxtaposed trawl bags being positioned at each of at least two depth levels,
wherein at least one of the trawl bags for trawl opening spreading has attached at its opening an elongate, rigid spreading member,
and
wherein caught seafood/biomass is continuously emptied from the trawl bags during trawling via an injector assisted suction hose connected at one end thereof to a bottom end of a respective one of the trawl bags, and at an upper and other end of the suction hose to the trawler vessel.

2. A method as disclosed in claim 1, wherein the trawl bags are joined along horizontally adjacent and/or vertically adjacent mouth portions.

3. A method as disclosed in claim 1, wherein spreading of trawl opening of trawl bags which are deployed according to feature a) is performed by attaching to the uppermost of the trawl bags at an upper part of its opening said elongate, rigid spreading member.

4. A method as disclosed in claim 1, wherein spreading of trawl opening of said at least two trawl bags which are deployed according to feature b) is performed by attaching such elongate, rigid spreading member to each of the uppermost of the trawl bags at an upper part of its respective opening.

5. An arrangement for trawling by means of a single trawler vessel, the arrangement comprising:
a plurality of trawl bags towable by said single trawler vessel, such plurality of trawl bags deployable as one of:
a) trawl bags positioned one above the other, and
b) at least two juxtaposed trawl bags being positioned at each of at least two depth levels,
an elongate, rigid trawl opening spreading member which is attached to at least one of the trawl bags, and
a plurality of suction equipment configured to continuously empty caught seafood/biomass from the trawl bags during trawling, each suction equipment comprising a suction hose with an injector device, said suction hose connected to a bottom end of a respective one of the trawl bags to allow said seafood/biomass to be passed through the suction hose, by aid of the associated injector, to the trawler vessel.

6. An arrangement as disclosed in claim 5, wherein the trawl bags are joined along horizontally adjacent and/or vertically adjacent mouth portions.

7. An arrangement as disclosed in claim 6, wherein the trawl bags are joined at least two points along horizontally adjacent and/or vertically adjacent mouth portions.

8. An arrangement as disclosed in claim 5, wherein said elongate, rigid trawl opening spreading member is attached to the uppermost of the trawl bags which are deployed according to feature a) at an upper part of its opening for spreading of trawl opening of the trawl bags.

9. An arrangement as disclosed in claim 5, wherein such elongate, rigid trawl opening spreading member is attached to each of the uppermost of the trawl bags which are deployed according to feature b), the attachment being at an upper part of its respective opening for spreading of trawl opening of said trawl bags.

10. An arrangement as disclosed in claim 5, wherein said elongate, rigid trawl opening spreading member is formed as one of a rigid tube, rigid pipe, rigid rod and a rigid tubular member having internal stiffening members or stays, and wherein said elongate, rigid trawl opening spreading member has cross-sectional profile being at least one of: circular, oval, polygonal, water drop shaped, conic section shaped, hydrofoil or aerofoil shaped, and any suitable hydro-dynamical shape.

11. A method for trawling by means of a single trawler vessel, the method comprising:
providing at least one set of a plurality of trawl bags to be towed by means of said single trawler vessel,
wherein such plurality of trawl bags are deployed by positioning the trawl bags one above the other, the uppermost of the trawl bags having an upper opening portion provided with a plurality of floats,
wherein an elongate, rigid trawl opening spreading member is used for spreading an opening the uppermost trawl bag and thereby a trawl bag below, said spreading being effective by attaching said spreading member to a lower opening portion of the uppermost trawl bag and to an upper opening portion of the trawl bag below,
wherein said at least one set of a plurality of trawl bags is towed by means of at least one tow line extending between the trawler vessel and said rigid, elongate spreading member, and
wherein caught seafood/biomass is continuously emptied from the trawl bags during trawling via an injector assisted suction hose connected at one end thereof to a bottom end of a respective one of the trawl bags, and at an upper and other end of the suction hose to the trawler vessel, said seafood/biomass being passed via the suction hose to the trawler vessel.

12. A method according to claim 11,
wherein a first of the trawl bags is made to form the uppermost trawl bag with an upper and a lower opening portion;
wherein a second of the trawl bags is made to form the lower trawl bag with an upper and a lower opening portion;
wherein said lower opening portion of the uppermost trawl bag trawl opening is connected at least two points to said upper opening portion of the lower trawl bag trawl opening; and
wherein a weight or sinker is attached at least a respective end of the lower opening portion of the lower trawl bag trawl opening.

13. A method as disclosed in claim 11, wherein tension lines are provided so as to extend from a respective outer end of said upper opening portion of the uppermost trawl bag opening to the outermost positioned fastening points on the rigid, elongate spreading member.

14. A method as disclosed in claim 13, wherein a tension line is provided to extend from outermost positioned fastening points on the rigid, elongate spreading member down to said sinker or weight.

15. A method as disclosed in claim 1 when applied to at least two trawl bags positioned one above the other, wherein at least two sets of said plurality of trawl bags are deployed in a spaced apart relationship.

16. A method as disclosed in claim 15, wherein said at least two sets of said plurality of trawl bags are towed either from a stern region of the trawler vessel or from a respective outrigger on either side of trawler vessel.

17. An arrangement for trawling by means of a single trawler vessel at least one set of a plurality of trawl bags,
wherein such plurality of trawl bags are deployable by the trawl bags being positioned one above the other, the uppermost of the trawl bags having an upper opening portion provided with a plurality of floats,
wherein trawl opening spreading means is provided for spreading an opening the uppermost trawl bag and thereby a trawl bag below, said spreading means configured as an elongate, rigid trawl opening spreading member, said spreading member being attachable to a lower opening portion of the uppermost trawl bag and to an upper opening portion of the trawl bag below,
wherein at least one tow line attachment means is provided on said elongate, rigid trawl opening spreading member for attachment to a tow line dimensioned to extend between the trawler vessel and said rigid, elongate spreading member for towing said at least one set of a plurality of trawl bags, and
wherein trawl bag catch emptying means are provided and configured to continuously empty caught seafood/biomass from the trawl bags during trawling via an injector assisted suction hose connected to a bottom end of a respective one of the trawl bags and at an upper end connected to the vessel, to thereby let said seafood/biomass being able to pass via the suction hose to the trawler vessel.

18. An arrangement as disclosed in claim 17,
wherein a first of the trawl bags is made to form the uppermost trawl bag with an upper and a lower opening portion;
wherein a second of the trawl bags is made to form the lower trawl bag with an upper and a lower opening portion;
wherein said lower opening portion of the uppermost trawl bag trawl opening is connected at least two points to at least two points on said upper opening portion of the lower trawl bag trawl opening; and
wherein a weight or sinker is attached at least a respective end of the lower opening portion of the lower trawl bag trawl opening.

19. An arrangement as disclosed in claim 17, wherein tension lines extend from a respective outer end of said upper opening portion of the upper trawl bag opening to the outermost positioned fastening points on the rigid, elongate spreading member.

20. An arrangement as disclosed in claim 19, wherein a respective tension line extends from each of the outermost positioned fastening points on the rigid, elongate spreading member down to said sinker or weight.

21. An arrangement as disclosed claim 17, wherein each trawl bag is fastened to the rigid, elongate spreading member at points that are either dedicated for the respective trawl bag or at points common to both trawl bags.

22. An arrangement as disclosed in claim 17, wherein said elongate, rigid trawl opening spreading member is formed as one of a rigid tube, rigid pipe, rigid rod and a rigid tubular member having internal stiffening members or stays, and wherein said elongate, rigid trawl opening spreading member has cross-sectional profile being at least one of: circular, oval, water drop shaped, conic section shaped, hydrofoil or aerofoil shaped, and any suitable hydro-dynamical shape.

23. A method for trawling by means of at least one trawl bag towed by a single trawler vessel, using a plurality of floats attached to an upper opening portion of the trawl bag,
wherein spreading an opening of the trawl bag is made by attaching an elongate, rigid trawl opening spreading member to a lower opening portion of the trawl bag, and
wherein towing of said trawl bag is effected using at least one tow line extending between the trawler vessel and said rigid, elongate spreading member.

24. A method as disclosed in claim 23, the method further comprising:
continuously emptying caught seafood/biomass from the trawl bag during trawling via an injector assisted suction hose connected at one end to a bottom end of the trawl bag and at the other end to the trawler vessel, to allow said seafood/biomass to pass via the suction hose to the trawler vessel.

25. A method as disclosed in claim 23, wherein said elongate, rigid trawl opening spreading member is formed as one of a rigid tube, rigid pipe, rigid rod and a rigid tubular member having internal stiffening members or stays, and said member having cross-sectional profile being at least one of: circular, oval, polygonal, water drop shaped and conic section shaped.

26. A method as disclosed in claim 23, wherein tension lines are provided so as to extend from a respective outer end of said upper opening portion of trawl bag opening to respective outermost positioned fastening points on the rigid, elongate spreading member.

27. A method as disclosed in claim 23, wherein at least two trawl bags are towed by the trawler vessel and are deployed in a spaced apart relationship, said towing being performed from a stern region of the trawler vessel or from a respective outrigger on either side of trawler vessel.

28. An arrangement for trawling a trawl bag by means of a single trawler vessel, an elongate, rigid trawl opening spreading member being attachable to an upper part of the trawl opening for spreading of trawl opening,
wherein suction equipment is provided and configured to continuously empty caught seafood/biomass from the trawl bag during trawling, the suction equipment comprising a suction hose with an injector device, said suction hose connected to a bottom end of the trawl bag to allow said seafood/biomass to be passed through the suction hose, by aid of the associated injector, to the trawler vessel, and
wherein said elongate, rigid trawl opening spreading member being formed as one of a rigid tube, rigid pipe, rigid rod and a rigid tubular member having internal stiffening members or stays.

29. An arrangement according to claim 28, wherein said spreading member has a cross-sectional profile being at least one of: circular, oval, water drop shaped and conic section shaped.

30. An arrangement for trawling by means of a single trawler vessel, the arrangement comprising:
a plurality of floats attached to an upper opening portion of a trawl bag,
an elongate, rigid trawl opening spreading member configured for spreading an opening the trawl bag,
wherein said spreading member is attached to a lower opening portion of the trawl bag, and
wherein at least one tow line attachment means is provided on said elongate, rigid trawl opening spreading member for attachment to a tow line dimensioned to extend between the trawler vessel and said rigid, elongate spreading member for towing said trawl bag.

31. An arrangement as disclosed in claim 30, further comprising:
trawl bag catch emptying means configured to continuously empty caught seafood/biomass from the trawl bag during trawling via an injector assisted suction hose connected at one end to a bottom end of the trawl bag and at the other end to the trawler vessel, to enable said seafood/biomass to pass via the suction hose to the trawler vessel.

32. An arrangement as disclosed in claim 30, wherein a tension line extends from a respective outer end of said upper opening portion of the trawl bag opening to respective outermost positioned fastening points on the rigid, elongate spreading member.

33. A method for trawling by means of a single trawler vessel, the method comprising:
towing at least one trawl bag from each of a port side outrigger and a starboard outrigger of the trawler vessel, and spreading an opening of such trawl bag by means of an elongate, rigid trawl opening spreading member towed by the trawler vessel from the respective outrigger thereof, said spreading member being attachable to an upper opening portion of the trawl bag,
wherein caught seafood/biomass is continuously emptied from the trawl bags during trawling via an injector assisted suction hose connected to at one end thereof to a bottom end of a respective one of the trawl bags and at the other end to the trawler vessel, to thereby allow said seafood/biomass to pass via the suction hose to the trawler vessel.
